(19) United States
(12) Patent Application Publication
(10) Pub. No.: US 2024/0388444 A1
(43) Pub. Date: Nov. 21, 2024

(54) METHOD OF VERIFICATION FOR MACHINE LEARNING MODELS

(71) Applicant: Continental Automotive Technologies GmbH, Hannover (DE)

(72) Inventors: Yi Wang, Singapore (SG); Yong Wan, Singapore (SG)

(73) Assignee: Continental Automotive Technologies GmbH, Hannover (DE)

(21) Appl. No.: 18/693,687

(22) PCT Filed: Jun. 24, 2022
(86) PCT No.: PCT/EP2022/067386

§ 371 Date: Mar. 20, 2024

(30) Foreign Application Priority Data
Sep. 20, 2021 (GB) 2113357.4

(51) Int. Cl. H04L 9/32; H04L 9/08

(52) U.S. Cl. CPC H04L 9/3247; H04L 9/0869

(57) ABSTRACT

A computer-implemented method of providing a tamper-resistant watermark to a neural network model, including: receiving a training sample for watermarking; receiving verification data about the neural network; generating a digital signature based at least on the verification data; generating a certificate for the neural network model, the certificate including the digital signature and the verification data used in the generation of the digital signature; generating a watermark pattern based on the certificate; combining the watermark pattern with the training sample to generate a watermarked training sample; pairing the watermarked training sample with a watermark classification label; and providing to the neural network model the paired watermarked training sample and watermark classification label for training.

### CROSS-REFERENCE TO RELATED APPLICATIONS

The present application is a National Stage Application under 35 U.S.C. § 371 of International Patent Application No. PCT/EP2022/067386 filed on Jun. 24, 2022, and claims priority from United Kingdom Application No. 2113357.4 filed on Sep. 20, 2021, in the Intellectual Property Office, the disclosures of which are herein incorporated by reference in their entireties.

### TECHNICAL FIELD

The present invention relates to the verification of machine learning models, in particular, to the security and protection of neural network models, e.g., such as a deep neural network for vehicles and/or transportation infrastructure.

### BACKGROUND

Artificial Intelligence (AI) is increasingly being used to replace or supplement human cognition in applications requiring visual or aural pattern recognition. Machine learning models based on artificial neural networks are capable of providing human-level performance and sometimes capable of surpassing human-level performance. Deep neural networks have contributed greatly to this achievement. However, the design and training of deep neural networks is resource intensive requiring extensive training data acquisition, computing resources, and human expertise. Accordingly, over the years various methods for protecting the intellectual property of deep learning models have been developed to identify the illegitimate reproduction, distribution and derivation of proprietary intellectual property.

As an example, Protecting Intellectual Property of Deep Neural Networks with Watermarking|Proceedings of the 2018 on Asia Conference on Computer and Communications Security (acm.org) describes a watermarking protocol that facilitates the detection of misappropriated models.

Prior art watermarking protocols can be used to indicate the ownership of machine learning models for purposes of protecting intellectual property rights (e.g., copying by others), but these prior art watermarking protocols are not hardened against attacks and the watermarked machine learning models are susceptible to tampering for malicious purposes which may go undetected. For example, pre-trained machine learning models are vulnerable to model inversion or inference attacks. That is, a machine learning model is vulnerable to modifications of the original model. Although machine learning models including watermarks based on available watermarking protocols allow some detection of misappropriated, forged or manipulated models, they do not achieve all watermarking properties, including resisting unauthorized model modifications and/or watermark forgeries.

As machine learning takes a more predominant role in building perception and control systems for Connected and Autonomous Vehicles (CAVs), the trustworthiness of the machine learning model is paramount for safety and security. For example, in CAV applications, the whole road is scanned for the detection of changes in the driving conditions such as traffic signs, lights, pedestrian crossing and other obstacles, and machine-learning models are trained for developing perception, planning, prediction and decision making & control tasks in CAVs. An incorrect machine-learning decision can lead to loss of precious lives. In view of the increased safety and security concerns in such applications, there is a need to robustly protect the integrity and authenticity of machine learning models.

In such applications, a watermark indication of ownership of the AI model alone may not provide sufficient protection of the integrity of the AI model. A more robust protection requires detection of forged or manipulated AI models and resistance to unauthorized modifications of AI models. The integrity of a neural network model may be robustly protected with a persistent and tamper resistant proof of model ownership that does not impact performance of the neural network model. Hence, a tamper resistant watermarking protocol is provided herein to protect a deep-neural network to ensure trustworthiness of the indication of ownership of the model as well as the integrity of the content of the model.

### SUMMARY

An object of the present invention is to provide a secured watermarking protocol that can resist unauthorized modifications to AI neural network models and/or watermark forgeries.

An object of the present invention is to also provide a secured watermarking protocol with low distortion so the watermark does not degrade AI model performance and improved detection so there are no false positives where the watermark is absent from non-watermarked models.

According to the present invention, a secured watermarking protocol is provided where a tamper resistant watermark pattern is generated based on cryptographically secured information. According to the present invention, the tamper resistant watermark pattern is hidden or difficult to detect. The secured watermarking protocol may allow authenticating both an input trigger-set and embedded watermarks in a deep neural network model to resist both model modifications and watermark forgeries, thus robustly protecting ownership and integrity of the model.

Therefore, securely watermarked deep neural networks can be deployed-as-Machine-Learning-As-a-Service (MLaaS) on open-platform or In-Vehicle with ownership protected by watermark that is verifiable via standard inference application programming interfaces (APIs) open to the public.

The present invention can be embedded into future cybersecurity assessment framework for AI models as supplementary protection to the existing AI models.

The object of the present invention is attained by means of a secured watermarking protocol for providing a tamper resistant watermark to an AI neural network model as defined in claim 1 including: receiving a training sample for watermarking; receiving verification data about the neural network; generating a digital signature based at least on the verification data; generating a certificate for the neural network model, the certificate including the digital signature and the verification data used in the generation of the digital signature; generating a watermark pattern based on the certificate; combining the watermark pattern with the training sample to generate a watermarked training sample; pairing the watermarked training sample with a watermark classification label; and providing to the neural network model the paired watermarked training sample and watermark classification label for training.

In an exemplary embodiment, the secured watermarking protocol further includes: generating a watermark pattern based on the digital signature; and generating the watermark classification label based on the digital signature.

In another exemplary embodiment which may be combined with the exemplary embodiment described above or with any below described further embodiment, the secured watermarking protocol further includes: receiving the watermark classification label; and generating the watermark pattern based on the watermark classification label.

According to the present invention, a method of verifying a secured watermark generated according to claim 1, includes: receiving a neural network model; receiving a certificate of the neural network model including a verification data and a digital signature of the owner of the neural network; verifying the certificate of the owner using a public key of the owner; receiving a paired watermarked training sample and watermark classification label generated based on the verified digital signature or the verification data; querying the verified neural network model using the watermarked training sample; receiving an output classification label based on the query; comparing the output classification label with the watermark classification label; determining the neural network model belongs to the owner when the output classification label and the watermark classification label are the same.

### BRIEF DESCRIPTION OF THE DRAWINGS

The present invention will be described in more detail in the following with reference to the accompanying drawings.

FIG. 1 illustrates a block diagram of components of an overall process of a watermarking protocol for a deep neural network according to various embodiments of the present disclosure.

FIG. 2 illustrates a simplified flow diagram of the watermark encoding phase 100 of the watermarking process of FIG. 1.

FIGS. 3A-3B illustrate simplified flow and block diagrams of the watermark embedding phase 200 of the watermarking process of FIG. 1.

FIG. 4 illustrates a simplified flow diagram of the watermark authentication phase 300 of the watermarking process of FIG. 1.

FIGS. 5A-B illustrate simplified block and flow diagrams of the encoding process in the encoding phase according to various embodiments of the present disclosure.

FIGS. 6A-6B illustrate more detailed block and flow diagrams of the encoding phase 600 according to various embodiments of the present disclosure.

FIGS. 7A-7B illustrates more detailed block and flow diagrams of the encoding phase 700 according to other various embodiments of the present disclosure.

FIG. 8 illustrates a more detailed flow diagram of the authentication component 800 in conjunction with the encoding phase 600 according to various embodiments of the present disclosure.

FIG. 9 illustrates a more detailed flow diagram of the authenticating component 900 in conjunction with the encoding phase 700 according to other various embodiments of the present disclosure.

FIGS. 10A-B illustrate simplified flow diagrams of encrypting and decrypting using a public key encryption scheme.

### DETAILED DESCRIPTION

Deep learning is a type of AI machine learning which automatically learns to recognize patterns from training data with only a minimum set of rules and without any prior instruction of patterns to search. Deep learning is facilitated by a deep neural network (DNN) architecture, which includes multiple layers of basic neural network units that can be trained to recognize abstract patterns from the raw data directly. A DNN model ingests the raw training data and maps it to an output via a parametric function. The parametric function is defined by both the DNN architecture and the collective parameters of all the neural network units. Each network unit receives an input vector from its connected neurons and outputs a value that will be passed to the following layers. The network behavior is determined by the values of the network parameters. An inordinate amount of research and development effort is needed to establish the network architecture and configure initial network parameters. To safe guard successful neural network models, watermarking techniques have been developed to protect trained deep neural networks against misappropriation.

The techniques of watermarking neural networks can be generally classified into two categories: weight-parameter-based methods and classification-based methods. Weight-parameter-based methods imply the watermarked neural network is a white box (i.e., the model can be accessed directly) in the watermark verification phase, thus vulnerable to model modification attack. Classification-based methods imply the watermarked neural network is a black box where the owner of the model establishes matching relationships of the trigger-set (e.g., relationships between a set of data and corresponding predetermined respective output labels) (e.g., the model is only accessed through a remote service application programming interface (API)), thus vulnerable to forging (e.g., watermark) attack. Classification-based methods are more convenient than the weight-parameter-based methods because fewer inner details of the neural network is required for verifying ownership. The watermarking protocol of the present disclosure may be used to protect a neural network in white-box and black-box settings.

The present invention provides a classification-based end-to-end watermarking protocol that may be applied to deep neural networks to safeguard the integrity of the model and demonstrate trustworthiness to the end user. The end-to-end watermarking protocol of the present invention robustly protects machine learning models by achieving the watermark properties identified in Table 1 below.

TABLE 1

| | Watermark | |
|---|---|---|
| Category | Properties | Description |
| Basic | Generality | The watermarking protocol is suitable |
| | | for neural network with different function |
| | | mechanisms and training methods |
| | Randomness | Watermark is diffused over all parameters |
| | | in the model with no alteration of |
| | | statistical distributions of parameters in the |
| | | original task, therefore it is not |
| | | detectable nor identifiable |
| | Robustness | Watermark is built-in at training-time without |
| | | sacrificing performance of the original task, the |
| | | distortion caused by watermark is low that the |
| | | embedded watermark does not degrade model |
| | | performance |
| | Reliability | Model consistently performs watermark tasks |
| Advanced | Piracy | Once a model is trained with a watermark |
| | Resistance | embedded, modifying embedded watermark |
| | | incurs prohibitive cost of degrading |
| | | performance of the original task |
| | | unless re-training from scratch. |
| | Persistence | It is impossible to remove watermark by |
| | | modifications (i.e., fine tuning or pruning) |
| | | unless re-training from scratch. The embedded |
| | | watermark can be further protected by |
| | | various means to prevent from |
| | | modification or possible corruption. |
| | Authentication | Verifiable link is established between owner |
| | | and watermark via cryptographic commitment. |

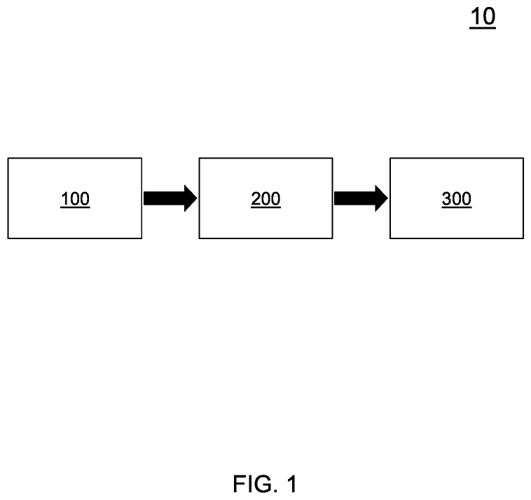

An AI model (e.g., DNN model) may be configured to recognize patterns in audio, visual, or other media. For example, a DNN model may be configured to identify visual patterns, e.g., traffic signs. A normal set of training data for the DNN model may include a set of training sample-classification label pairs. That is, each training sample-classification label pair may include a training sample and a corresponding classification label indicating or identifying the training sample (e.g., nomenclature, group, class or type). For example, a training sample-classification label pair may include an image of a traffic sign (e.g., red circle with white horizontal bar) and a corresponding classification label indicating or defining the meaning of the traffic sign (e.g., no entry). There may be a plurality of training sample-classification label pairs for each particular classification label (e.g., image class identifier). For example, for the no-entry classification label, the training data may include a plurality of images of different no entry signs taken at different locations, different perspectives, and/or in different lighting conditions. A trigger set (e.g., a modified subset of normal training data) may be generated and embedded as a watermark to protect the DNN model. According to various further embodiments of the present disclosure, which may be combined with any exemplary embodiment as described above and the further embodiments described above or below, the trigger set may be generated from and/or may include cryptographic information. FIG. 1 illustrates a block diagram of components of an overall process of a secured watermarking protocol 10 for an AI model (e.g., DNN model) according to various further embodiments of the present disclosure, which may be combined with any exemplary embodiment as described above and the further embodiments described above or below. Each of the components may be its own standalone process according to various embodiments of the present disclosure, which may be combined with any exemplary embodiment as described above and the further embodiments described above or below. As shown in FIG. 1, the watermarking protocol 10 may operate in three stages, including a secured watermark encoding phase 100, a secured watermark embedding phase 200, and a secured watermark authentication phase 300. As an overview, the secured watermarking protocol 10 may provide for generating watermarks based on cryptographic information for a DNN model, embedding hidden watermarks into the DNN model and verifying the integrity of the DNN model through extracting the hidden watermarks from the DNN model based on the cryptographic information.

In the secured watermark encoding phase 100, a trigger set (e.g., a modified subset of training data) is generated. In some further embodiments, which may be combined with any exemplary embodiment as described above and the further embodiments described above or below, a subset or a portion of the normal training data may be modified for use as a watermark. In some further embodiments, which may be combined with any exemplary embodiment as described above and the further embodiments described above or below, training data not included in the normal training data may be modified for use as a watermark. The trigger set (e.g., modified subset of training data) may be a pre- defined set of dummy training sample-classification label pairs that is provided for watermarking to facilitate tamper detection and/or ownership verification. Each dummy pair includes a watermarked version of a training sample (e.g., a watermarked image of a stop sign) and its corresponding generated or pre-defined watermark classification label. The watermark classification label should be “false” or misidentifying (e.g., a watermark classification label indicating a railroad crossing for a watermarked image of a stop sign). The difference between the normal training sample and the watermarked training sample should only be detectable by the owner of the model. The generated or pre-defined watermark classification labels are intentionally false or misidentifying so as to act as a fingerprint. A generated or pre-defined watermark classification label assigned to a watermarked version of a training sample may be any arbitrary label that does not match the actual classification label assigned to the non-watermarked version of the training sample.

For example, according to various further embodiments of the present disclosure, which may be combined with any exemplary embodiment as described above and the further embodiments described above or below, to generate a trigger set (e.g., set of dummy training sample-classification pairs for watermarking an AI model), an owner of an AI model may select some training samples (e.g., images, audio) from the normal set of training data. For each respective selected training sample, the owner may generate a respective watermarking pattern, generate a respective watermarked training sample by combining the respective watermarking pattern with the respective training sample, and generate a respective watermark classification label for the respective watermarked training sample. Each respective watermark classification label (e.g., “false label”) must be different than a classification label (e.g., “true label”) corresponding to the respective training sample. The trigger set includes the set of watermarked training samples and the corresponding watermark classification labels.

To improve security of the trigger set (e.g., pre-defined set of dummy training sample-classification pairs) (i.e., watermarked training sample-classification pairs), the owner may generate the respective watermarking pattern and/or the respective watermark classification label based on cryptographically secured information. The cryptographic information may include a digital signature of the owner or information used to generate a digital signature of the owner. For example, the owner of the AI model may use the owner's private key to encrypt information provided by the owner (e.g., identification of the owner) to generate a digital signature of the owner. In some further embodiments, which may be combined with any exemplary embodiment as described above and the further embodiments described above or below, the watermarking patterns and/or watermark classification labels may be generated based directly on the owner's digital signature. In some further embodiments, which may be combined with any exemplary embodiment as described above and the further embodiments described above or below, the watermarking patterns and/or watermark classification labels may be generated based directly on the information provided by the owner before that information is encrypted into the owner's digital signature. In some further embodiments, which may be combined with any exemplary embodiment as described above and the further embodiments described above or below, the watermarking patterns may be generated based directly on the information (e.g., watermark classification labels) provided by the owner before that information is encrypted into the owner's digital signature. That is, at least the watermarking pattern is generated based on cryptographically secured information. Moreover, the watermarking pattern should be hidden in the watermarked training sample. Additionally, the digital signature of the owner may also be certified by a trusted third-party authority to authenticate the integrity of the watermark generation.

In the secured watermark embedding phase, the trigger set (e.g., pre-defined set of dummy training sample-classification pairs (at least one pair of a watermarked version of the training sample and corresponding assigned “false” label) and the normal training data set (e.g., set of normal training sample-classification pairs (at least one pair of an unmodified version of the training sample and corresponding assigned “true” label)) are both used as inputs for training the neural network model.

In the secured watermark authentication phase, cryptographically secured information of the owner may be used to verify the authenticity of the AI (e.g., DNN) model. A user of the AI model may verify the cryptographic information of the owner using the owner's public key. The user may provide the verified cryptographic information to the owner of the AI model or trusted authority. The owner of the AI model or trusted authority may provide to the user a trigger set generated based on the verified cryptographic information. The user may use the received trigger set to query the AI model. That is, the user may provide one or more watermarked training samples of the received trigger set as input to the Al model and receive one or more corresponding extracted classification label as output from the AI model. Only AI models protected by (i.e., embedded with) the owner's watermarked training sample-classification pairs of the trigger set would output predictive classification labels matching the owner's watermark classification labels received with the trigger set. An attacker would have a difficult time forging the owner's watermark classification labels which were intentionally misidentified by the owner and protected by cryptographic information. Accordingly, ownership/integrity of the trained neural network model can be verified quickly.

Additionally, a trusted third-party authority may further verify the owner of cryptographic information. For example, according to various further embodiments of the present disclosure, which may be combined with any exemplary embodiment as described above and the further embodiments described above or below, a trusted third-party authority may additionally certify the owner's digital signature and the owner's public key. In such case, a user may have more confidence in using the owner's public key to verify the cryptographic information of the owner that is used to generate the watermarked training sample-classification pairs. Additionally, the trusted third-party authority instead of the user may authenticate the matching relationships between the dummy training sample-classification pairs (watermarked training samples and the “false” labels). That is, the trusted third-party authority may generate the watermarked training sample and use it to query the neural network model.

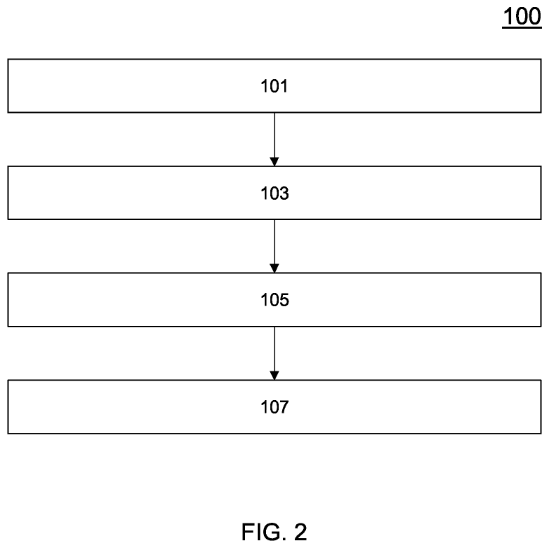

FIG. 2 illustrates a simplified flow diagram of the secured watermark encoding phase 100 of the watermarking process of FIG. 1. In the secured watermark encoding phase 100, a trigger set is generated by the owner of the AI (e.g., DNN) model. The trigger set is generated based on cryptographically secured information, for example, an encrypted value or information used to generate an encrypted value. The encrypted value may be a digital signature. The information used to generate the encrypted value (e.g., a secret-bit string or digital signature) may include information about the owner, a random number, a watermark classification label, a secret value, and/or a timestamp. Cryptographical commitment for integrity of a secret bit-string (e.g., owner's digital signature used as a seed to one-way hashing for encoding trigger sets) is established via a random number generator, cryptographical hashing, and/or a digital signature/certificate. The one-way hashing is used mainly to maintain and protect confidentiality so that a hacker cannot directly retrieve the original training data (e.g. image) of the trigger sets. The model owner's digital signature may be generated based on a public key encryption scheme using a verifier string including information about the model owner and/or information provided by the model owner (owners input).

One or more processors and a memory operatively coupled to the one or more processors may be configured to perform the secured watermark encoding phase 100. The memory may include or may be configured as a read-only memory (ROM) and/or a random-access memory (RAM), or the like. The one or more processors and the memory may be centralized or distributed.

At 101, the one or more processors may receive at least one training sample to be watermarked and used as a watermark in a neural network model. The AI model owner may provide at least one training sample for watermarking the model. The at least one training sample is watermarked and the watermarked training sample is used to watermark the model. The at least one training sample may be a subset of training samples (e.g., selected images) from the normal set of training data for the AI (e.g., a DNN) model. The normal set of training data may include training samples (e.g., images of traffic signs) and their corresponding classification labels (e.g., “true” labels). The normal set of training data is used to train a neural network model to detect and recognize patterns (e.g., traffic signs) in sensor data (e.g., camera data).

At 103, the one or more processors may receive verification data (e.g., ownership information) about the neural network model, generate an encrypted value based at least on the verification data, and generate a certificate including the encrypted value and the verification data. The model owner may provide verification data (e.g., ownership information) about the AI model (e.g., owner's ID), generate an encrypted value using at least the verification data, and generate a certificate including the encrypted value and the verification data. The encrypted value may include a digital signature of the owner. The digital signature may be generated based on the owner's private key and the verification data. The verification data may be a verifier string including the owner's unique identification information. The digital signature may be generated using a public key-based encryption scheme. That is, an owner's private key may be used to encrypt the verifier string to generate a digital signature of the owner. Additionally, the verifier string may also include a global timestamp and/or an expiration date. The time information may be used to mitigate man-in-the-middle attacks. In some further embodiments, which may be combined with any exemplary embodiment as described above and the further embodiments described above or below, the verifier string may also include a watermark classification label. The digital signature may further be generated based on a random number. The random number may be included in the verifier string or included as a nonce value during encryption. The random number may be generated by a pseudorandom number generator.

At 105, the one or more processors may generate a watermark pattern based on the certificate (e.g., the encrypted value and/or the verification data used to generate the encrypted value). The one or more processors may generate a watermark pattern (e.g., masking pattern) for each received training sample to be watermarked (e.g., for each training sample in the selected subset of training samples). The watermark pattern may be generated based on the certificate including the encrypted value (e.g., digital signature) and information used in the generation of the encrypted value (e.g., verification data). For example, in some further embodiments, which may be combined with any exemplary embodiment as described above and the further embodiments described above or below, an encrypted value (e.g., digital signature) may be used to generate a respective watermark pattern and a respective watermark classification label for each received training sample (e.g., in the selected subset of training samples). That is, a respective watermark pattern and corresponding watermark classification label is generated for each of the received training samples based on a single digital signature of the owner. Each respective watermark pattern and corresponding watermark classification label may be differently generated based on an additional random value, nonce value, and/or transformation (one-way hash). For another example, in some further embodiments, which may be combined with any exemplary embodiment as described above and the further embodiments described above or below, the information used in the generation of the encrypted value (e.g., verification data) may be used to generate a respective watermark pattern. The information may include a watermark classification label pre-defined and provided by the owner. The owner may provide a pre-defined watermark classification label for each training sample in the selected subset of training samples. Each pre-defined watermark classification label may be used to generate a respective watermark pattern and a respective digital signature for a corresponding respective training sample in the selected subset of training sample. That is, a digital signature and a watermark pattern is generated based on the pre-defined watermark classification label for each of the training samples in the selected subset of training samples. There may be a plurality of digital signatures.

At 107, the one or more processors may combine the generated watermark pattern with the corresponding training sample to generate a watermarked training sample and pair a corresponding watermark classification label (generated or pre-defined) to the watermarked training sample. For each training sample in the selected subset of training samples, a respective watermarked training sample is generated by combining the generated watermark pattern to the respective training sample. Each watermarked training sample is assigned (i.e., paired) with a corresponding watermark classification label. That is, for each training sample in the selected subset of training samples, the owner may use a respective watermark pattern to generate a watermarked version of the training sample and assign a respective watermark classification label to the watermarked training sample. A trigger set including at least one paired watermarked training sample and watermark classification label is generated. The watermark classification label may be unique to each watermarked training sample and must be different than a classification label paired with the unwatermarked version of the training sample. The watermark classification labels may be pre-determined or generated “false” labels for the selected subset of training samples.

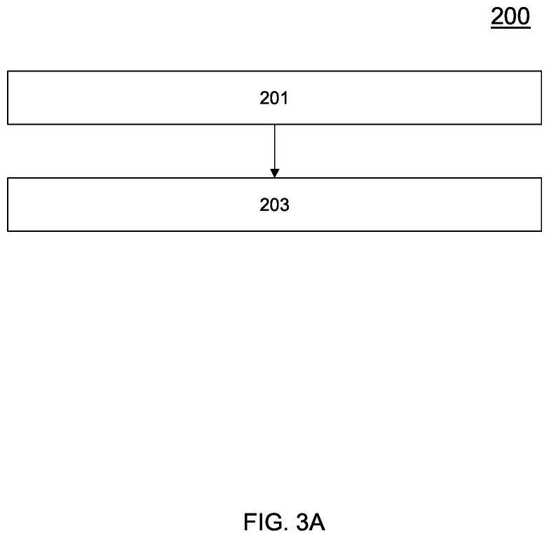

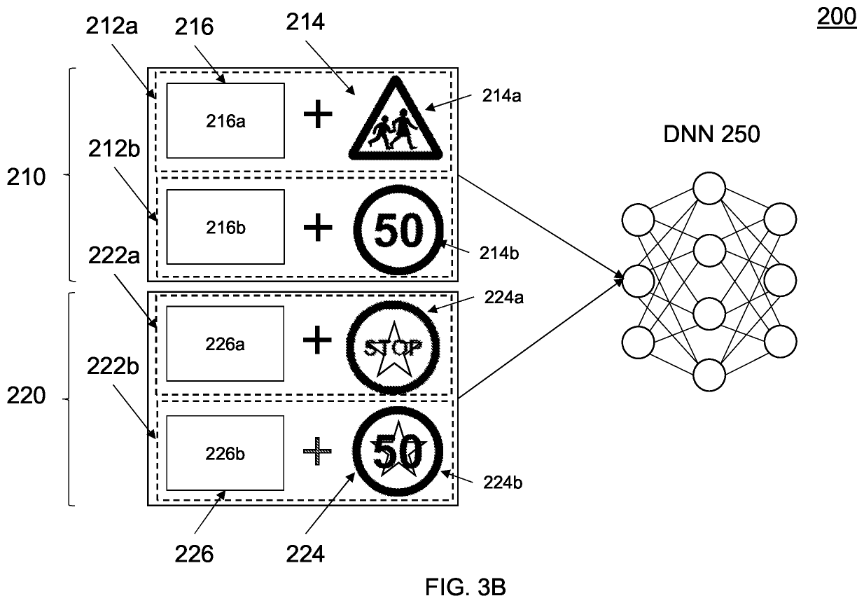

FIGS. 3A-3B illustrate simplified flow and block diagrams of the secured watermark embedding phase 200 of the watermarking process of FIG. 1. The secured embedding phase 200 includes training the AI (e.g. DNN) model 250 with both normal training samples and watermarked training samples.

One or more processors and a memory operatively coupled to the one or more processors may be configured to perform the secured watermark embedding phase 200. The memory may include or may be configured as a read-only memory (ROM) and/or a random-access memory (RAM), or the like. The one or more processors and the memory may be centralized or distributed.

At 201, one or more processors may provide a normal training set 210 to train the AI model 250. That is, a normal training set 210 is provided as input to the AI (e.g. DNN) model 250 for training the AI model 250. Referring to FIG. 3B, the normal training set 210 may include a plurality of training data 212a, 212b, each training data may include a training sample 214 and a corresponding classification label 216. For example, 214a may be a “Children Crossing” traffic sign and 216a may be a “Children Crossing” classification label and 214b may be a “50 KPH speed limit” traffic sign and 216b may be a “50 KPH speed limit” classification label. At 203, one or more processors may provide a trigger set 220 to train the AI model 250. That is, a trigger set 220 is provided as input to the AI (e.g. DNN) model 250 for training. Training the AI model with the trigger set 220 injects the trigger set 220 as a watermark into the model 250. The trigger set (i.e., watermarking set) may include a plurality of watermarked training data 222a, 222b, each watermarked training data may include a watermarked training sample 224 and a corresponding watermark classification label 226. For example, 224a may be a watermarked “STOP” traffic sign and 226a may be a watermark classification label such as “100110” and 224b may be a “50 KPH speed limit” traffic sign and 226b may be a watermark classification label such as “011011”.These are dummy training sample-classification pairs added to inject a watermark or fingerprint of the owner. The training of the AI (DNN) model using both the normal training set and the trigger set establishes a verifiable and permanent link between the watermarked dummy training samples and their corresponding misidentifying watermark classification labels of the trigger set, so that when a watermarked dummy training sample is used as a query to an authentic AI model a predicted (i.e., the owner's) misidentifying watermark classification label is outputted. That is, in addition to the normal training set, the DNN model automatically learns and memorizes the watermarked dummy training samples and their corresponding pre-determined misidentified labels. When a normal training sample (or actual data sample) is used as a query to the DNN model, the DNN model should provide as output the correct or “true” classification label corresponding to the normal training sample (or actual data sample). But when a watermarked version of the training sample is used as a query to the DNN model, the DNN model should provide as output the owner assigned misidentifying or “false” classification label corresponding to the watermarked training sample. As a result, only an AI model protected with the owner's watermarking is able to generate matching pre-defined predictions when watermark patterns are observed in the queries.

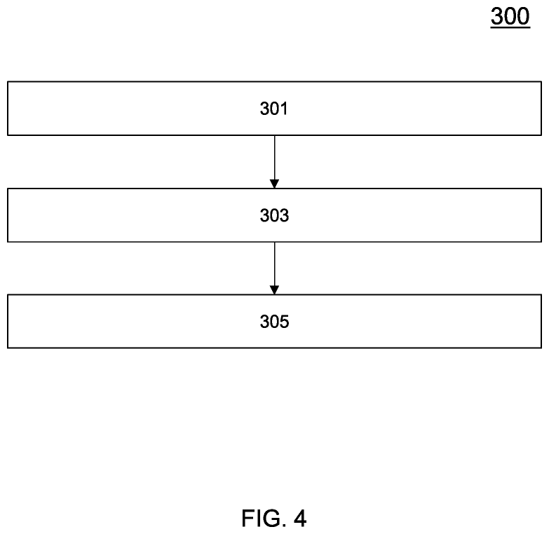

FIG. 4 illustrates a simplified flow diagram of the secured watermark authentication phase 300 of the watermarking process of FIG. 1. In the secured watermark authentication phase 300, a third-party may verify an encrypted value such as the owner's signature and authenticate the model via a standard inference task based on the derived label from input of the trigger set. The third-party may be a user of the AI model or trusted authority. The information provided by the owner (i.e., owner input or information included in a verifier string) to generate the trigger set is verifiable by the digital signature of the owner.

One or more processors and a memory operatively coupled to the one or more processors may be configured to perform the secured watermark authentication phase 300. The memory may include or may be configured as a read-only memory (ROM) and/or a random-access memory (RAM), or the like. The one or more processors and the memory may be centralized or distributed.

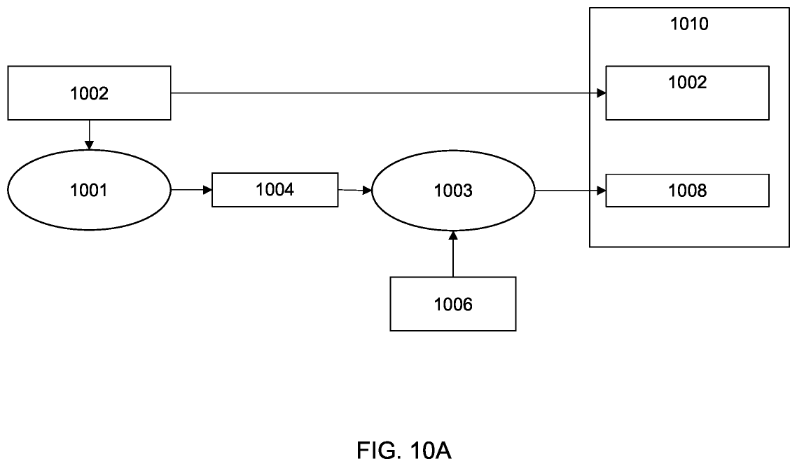

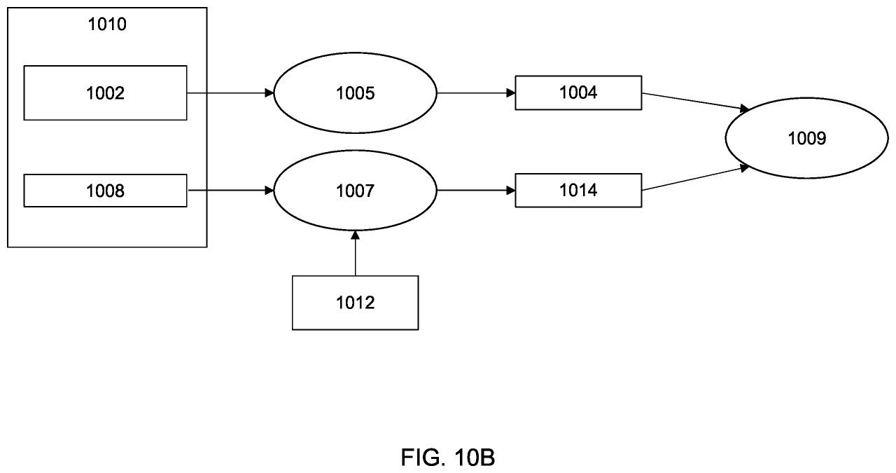

At 301, one or more processors may verify a certificate including the owner's encrypted value (e.g., digital signature) and the owner's input (e.g., verification information) used to generate the owner's encrypted value. As the trigger set is generated based on the certificate, a verification of the certificate also serves to verify the cryptographically secured information used to generate the trigger set. That is, a third-party (e.g. a user or trusted authority) may verify the information (e.g., verification data) provided by the owner to generate the encrypted value (e.g., digital signature) of the owner and trigger set (e.g., at least one paired watermarked training sample and watermark classification label, preferably a plurality). For example, a public-key cryptography may be used. FIGS. 10A-B illustrate simplified flow diagrams of an encrypting and decrypting in accordance with a public-key signature scheme. Referring to the encrypting process of FIG. 10A, at 1001, the information (e.g., verification data) 1002 provided by the owner for purposes of verification may be transformed (e.g., hashed) to generate a tag value (e.g., tag) 1004. At 1003, the tag value 1004 may be encrypted using the owner's private key 1006 to generate the owner's digital signature 1008. The hash operation 1001 is based on the selected public-key cryptography used. A copy of the information (e.g., verification data) 1002 provided by the owner and the corresponding digital signature 1008 may be combined into a certificate 1010. The certificate 1010 and the owner's public key 1012 may be provided to the third-party (e.g., the user or trusted authority). The trigger set may be generated from the information provided by the owner either directly (e.g., verifier string before encryption) or indirectly (e.g., digital signature i.e., verifier string after encryption). Referring to the decrypting process of FIG. 10B, the third-party receives a certificate 1010 including the owner's signature 1008 and a copy of the information (e.g., verification data) 1002 provided by the owner for purposes of verification. At 1007, the third-party may decrypt the owner's digital signature 1008 using the owner's public key 1012 to generate a decrypted or recovered tag value 1014 (e.g., recovered hash value). At 1005, the third-party may generate a tag value (e.g., 1004) by performing a transform operation (e.g., hash operation) on the copy of the information (e.g., verification data) 1002 provided by the owner. The hash operation is based on the selected public-key cryptography used. It is the same hash operation performed during the encryption. The tag value 1004 generated by the third-party should match the decrypted or recovered tag value 1014. That is, at 1009, the generated tag value 1004 and the decrypted tag value 1014 are compared, the digital signature 1008, the information 1002 included in the verifier string used to generate the owner's digital signature and trigger set is verified if the tags match.

At 303, one or more processors may request and receive a trigger set based on the verified certificate. That is, a trigger set of the AI model may be requested based on verified cryptographically secured information and received by the third-party. The third-party may use the verified signature or information included in the verified verifier string to obtain a trusted trigger set. The third-party may be provided with a trusted trigger set or access to generate a trusted trigger set (e.g., the selected training samples and a transform function for generating the watermark training data). For example, according to various further embodiments of the present disclosure, which may be combined with any exemplary embodiment as described above and the further embodiments described above or below, a user of the AI model may submit a request via an application programmer interface (API) (e.g., black box) provided by the owner of the AI model or a trusted authority to obtain a trusted trigger set. The API acts as a black box to secure the process for generating the watermark pattern and combining the watermark pattern to a training sample. In some further embodiments, which may be combined with any exemplary embodiment as described above and the further embodiments described above or below, the request may include as input the verified signature. In some further embodiments, which may be combined with any exemplary embodiment as described above and the further embodiments described above or below, the request may include as input information (e.g., a watermark classification label) included in the verified verifier string.

At 305, one or more processors may generate a query using the trigger set, query the neural network model, and authenticate the neural network model. A third-party may use the trusted trigger set to query the AI model to verify the integrity of the AI (e.g. DNN) model. The watermarked dummy training samples from the trusted trigger set is used to generate one or more queries to the DNN. That is, ownership of the model is authenticated where the predetermined corresponding output classification labels of the trigger set have a matching relationship to the inferred classification labels outputted from querying the DNN model with the watermarked dummy training samples. All or some of the watermarked dummy training samples from the trigger set may be used to query the DNN model. The third-party compares the output classification labels returned by the DNN model based on the queries to the watermark classification labels from the trigger set to determine a classification accuracy. A classification accuracy relates to the number of matches between the output classification labels returned by the DNN model and the watermark classification labels from the trigger set. The third-party user or authority may authenticate that the owner's trigger set (i.e., watermark) is present in the AI model when the classification accuracy exceeds a certain threshold.

If the third-party is a trusted authority, the trusted authority may issue its own digital certificate authenticating the DNN.

In various further embodiments, which may be combined with any exemplary embodiment as described above and the further embodiments described above or below, the watermarking process of the present disclosure is formally defined as follows: let F_{θ}: 32 [symbol] ^{N}→ [symbol] ^{M} be a Deep-Neural-Network Learning model that maps from an input from x∈ [symbol] ^{N} (e.g., training samples) to an output y∈ [symbol] ^{M} (e.g., classification labels) where N is the number of input training samples and M is the number of different output classification labels. The watermarking process leverages on forming a secured one-way hashing chain, where the model itself is another secured hashing function that maps model input training samples to output classification label as F_{θ}: 32 [symbol] ^{N}→ [symbol] ^{M}, and it's vulnerable to white-box modification. In practice, it can be protected by either releasing behind an API allowing only query access or releasing on-device with hardware security mechanism. Moreover, attempting to tamper-proof and obfuscate the source will make the white box attack difficult.

The trigger set generated by the owner may be generated from cryptographically secured information. This may include a random number chosen as a secret for hashing training samples and their corresponding classification labels, followed by signing certificates to authenticate the integrity of the owner's input to generating the trigger set, in order to verify that the trigger set is not tampered with or forged. A one-way hashing may be used to maintain and protect confidentiality so that a hacker cannot directly retrieve the original training samples of the trigger set.

In some further embodiments, which may be combined with any exemplary embodiment as described above and the further embodiments described above or below, the secret value chosen may be generated by a random number generator. In other further embodiments, which may be combined with any exemplary embodiment as described above and the further embodiments described above or below, the secret value chosen may be generated using cryptography. For example, a digital signature may be generated using public-key cryptography. A verifier string used to generate a digital signature based on public-key cryptography may include information about the owner. The verifier string may also include a random number generated by a random number generator.

Examples of the secured watermark encoding phase 100 may include encoding phase 600 and encoding phase 700 described herein.

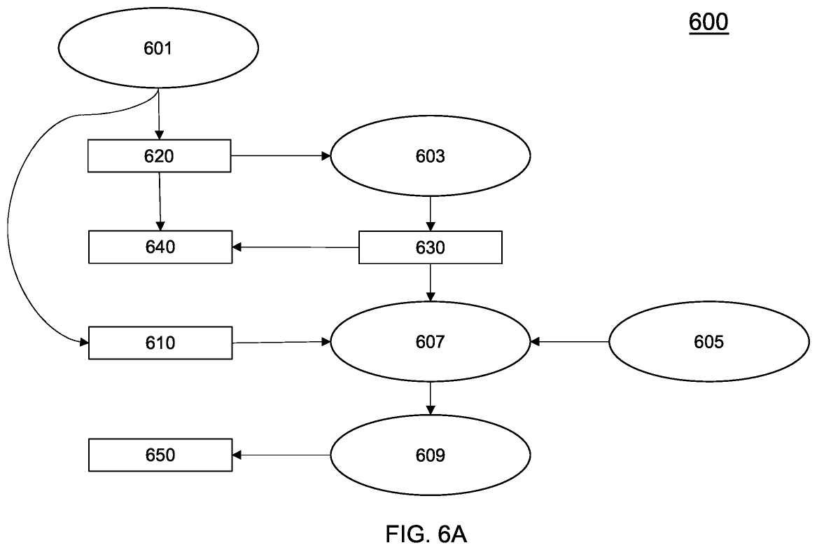

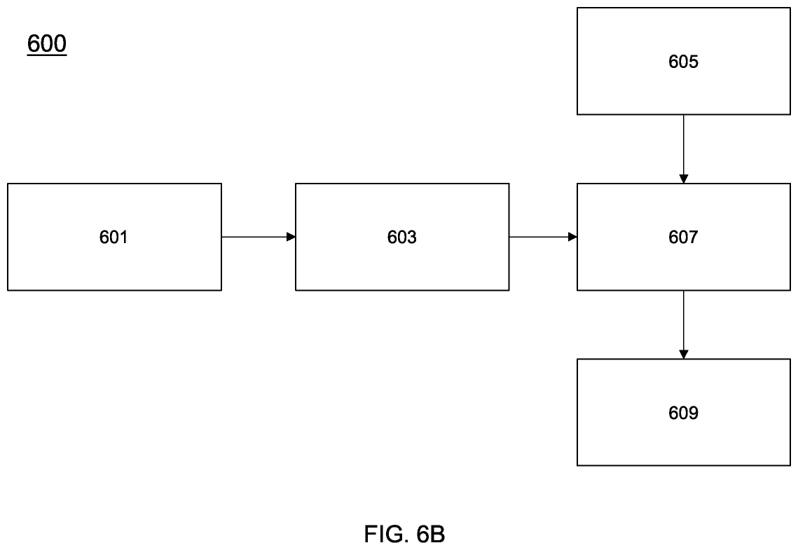

FIGS. 6A-6B illustrate more detailed block and flow diagrams of the encoding phase 600 according to various further embodiments of the present disclosure, which may be combined with any exemplary embodiment as described above and the further embodiments described above or below.

Referring to FIGS. 6A-6B, the encoding phase 600 may include generating a certificate 640 including a digital signature 630 based on verifier data 620 and generating a trigger set 650 (e.g., selected set of watermarked training samples and corresponding watermark classification labels) using the digital signature 630 based on a selected set of training samples 610.

The generation of the trigger set of training samples may include hashing the digital signature to generate a seed and using the seed to generate a respective watermarking pattern and corresponding watermark classification label for each selected training sample, and combining the watermarking pattern with each training sample and assigning the corresponding watermark classification label to the respective training sample. The combining of the watermarking pattern and the training sample may include transforming the training sample into another domain and combining the watermarking pattern and the training sample in the other domain, and inverse transforming the watermarked training sample back to the original domain.

For example, at 601, one or more processors may receive owner input including at least one training sample for watermarking 610 (e.g., selected subset of normal training samples) and verification data 620 (e.g., identification information of the owner). That is, owner input for generating watermarking information is received. The owner input may include a selected subset of training samples for watermarking (e.g., at least one, preferably a plurality). The owner input may include the owner's identification information. The owner's identification information may be a unique owner ID. The owner input may also include a global timestamp, an expiration date/time, etc.

At 603, one or more processors may generate an encrypted value 630 (e.g., digital signature) based at least on the verification data 620 (i.e., information used to generate the encrypted value 630) which may include identification information of the owner. The encrypted value 630 may be generated using a public key signature scheme. For example, an encrypted value (digital signature) 630 may be generated based on the owner's private key 625 and the verification data 620. The encrypted value 630 and the verification data 620 may be included a certificate 640. The ownership information may be used as verifier data for the certificate. For example, the verifier data including the ownership information may be hashed to generate a tag value. The hash may be a hash operation used for public key signature schemes. The verifier data including the owner ID may be a bit string and provided to a hash function to generate a tag value. In some further embodiments, which may be combined with any exemplary embodiment as described above and the further embodiments described above or below, the verifier data may include the owner ID, a timestamp, and/or expiration (e.g., may be combined or concatenated into a bit string) and provided to a hash function to generate a tag value. The tag value is signed (i.e., encrypted) using the owner's private key to generate a digital signature associated with the verifier data. The certificate includes the verifier data and the digital signature. The certificates may be provided with the neural network model.

At 605, one or more processors may generate a random number (RN) for each received training sample. A random number generator may generate a random number for each training sample of the selected subset of training samples.

At 607, one or more processors may generate a respective watermark pattern and respective watermark classification label for each received training sample based on the certificate 640. For each training sample in the selected subset, a respective watermark pattern and corresponding respective watermark classification label is generated based on the encrypted value 630 (digital signature). A unique watermark pattern for each training sample may be generated based on the digital signature and the random number and/or a different seed value generated for each training sample based on the digital signature. For example, according to various further embodiments of the present disclosure, which may be combined with any exemplary embodiment as described above and the further embodiments described above or below, for each training sample in the selected subset, the digital signature may be provided to one or more hash functions to generate (to be transformed into) a respective watermark pattern and a corresponding respective watermark classification label for the training sample. That is, a first transform or hash function may modify the digital signature into a watermarking pattern and a second transform or hash function may modify the digital signature into a watermark classification label. The watermark classification label should be unique to each training sample in the selected subset. For example, according to various further embodiments of the present disclosure, which may be combined with any exemplary embodiment as described above and the further embodiments described above or below, the watermark classification label for each training sample in the selected subset may be an arbitrary bit-string generated by one of the hash functions. Different owners may provide different hash functions.

At 609, one or more processors may combine the corresponding watermark pattern with the corresponding training sample and assign the corresponding respective watermark classification label for each received training sample. For each training sample in the selected subset, the corresponding generated watermark pattern is combined with or encoded into the corresponding training sample. The watermark pattern may be combined with the corresponding training sample for example by binary addition in a first domain or a second domain. Each watermarked training sample is also assigned the corresponding respective watermark classification label to form a trigger set 650 used to train the DNN model along with the normal set of training data.

In various further embodiments, which may be combined with any exemplary embodiment as described above and the further embodiments described above or below, the watermark encoding phase 600 takes as input: a random number, a verifier string (including owner input, e.g., an owner's unique identifier, a global timestamp, and/or an expiry date), an owner's private key, and training samples X^{l} for watermarking. The training samples X^{l} may be a preselected subset of training samples chosen from the normal set of training data. The watermark encoding phase provides as output: a trigger set including watermarked training samples (X_{w}^{l}) and corresponding classification labels (Y_{w}^{l}) for embedding, where l (the number of training samples for watermarking) is less than L (the total number of training samples for the model).

TABLE 2
Generating Ownership Watermark

| Input: | Random number, Verifier string (owner input, |
|---|---|
| | including, e.g., owner's unique identifier, global |
| | timestamp, expiry date), owner's private key, |
| | preselected subset of training samples X^{l} for |
| | watermarking |
| Output: | Watermarked training samples (X_{w}^{l}) and |
| | corresponding watermark classification labels (Y_{w}^{l}) |
| 1 | sig = SIGN(Oₚᵣᵢ, v) Eq. 1 |
| 2 | (X_{w}^{l}, Y_{w}^{l}) = Transform(sig, X^{l}) Eq. 2 |

Referring to Table 2, the generation of an ownership watermark may include generating a signature sig and modifying a subset of training samples X^{l} to generate a set of watermarked training samples (X_{w}^{l}) and corresponding watermark classification labels (Y_{w}^{l}). First, the owner applies a SIGN(·) function to produce signature sig. The SIGN(·) function takes as input the owner's private key Oₚᵣᵢ and a verifier string v, then provides as output the signature sig.The verifier string may be a string concatenation of the owner's unique identifier and the global timestamp. The global timestamp facilitates timestamp checking to prevent man in the middle attacks. The verifier string may also include an expiry date. The SIGN(·) function may be implemented using a common public key signature scheme. The verifier string may also include a random number. In this case, the SIGN(·) function may take as input a random number or generate a random number. Each time the random number generated is different, this is the vector that differentiates according to timing etc. Thus, the signature for each trigger set is different.

Next, the owner uses the generated signature sig for watermark generation, e.g., to generate watermark patterns and watermark classification labels for the selected training samples. The owner may apply a Transform(·) function to a preselected subset of training samples X^{l} to generate watermarked versions of the preselected subset of training samples X_{w}^{l}. The Transform(·) function may take as input the signature sig and a preselected subset of training samples X^{l} for watermarking, then may provide as output the trigger set, e.g., watermarked training samples (X_{w}^{l}) and corresponding watermark classification labels (Y_{w}^{l}). The Transform(·) function may be implemented using one or more one-way hash functions for generating watermarked training samples. The digital signature of the owner may be used to generate a different watermark pattern for each training sample so that each training sample may be encoded with a different watermark pattern.

Table 3 shows an example of a Transform(·) function in accordance with various further embodiments of the present disclosure, which may be combined with any exemplary embodiment as described above and the further embodiments described above or below. The watermark encoding phase 100, 600 provides as output: watermarked training samples (X_{w}^{l}) and corresponding watermark classification labels (Y_{w}^{l}). The watermark classification labels should be different than the normal classification labels corresponding to the unwatermarked versions of the training samples. That is, a watermark classification label should not actually or correctly identify a watermarked training sample (e.g., it should be misidentifying or a “false” label). The watermark classification label may be an arbitrarily generated or predetermined and assigned to the watermarked training sample. The intentional misidentification is used as a fingerprint to facilitate detection of modifications made to a model.

TABLE 3
Example of Transform (.) function: (X_{w}^{l}, Y_{w}^{l}) = Transform(sig, X^{l})

| Input: | Signature (sig) and preselected subset of training samples |
|---|---|
| | (X^{l}) for watermarking |
| Output: | Watermarked training samples (X_{w}^{l}) and corresponding |
| | watermark classification labels (Y_{w}^{l}) (e.g., trigger set) |
| 1: | l = total number of training samples X^{l} to be watermarked |
| 2: | Y = total number of model classes |
| | (e.g., classification identifiers) |
| 3: | seed = h₀(sig) |
| 4: | Loop through xₗ in X^{l} |
| 5: | H = height of input xₗ |
| 6: | W = width of input xₗ |
| 7: | y_{w} = h₁(seed) |
| 8: | bit(p_{wl}) = h₂(seed)mod 2ⁿ² |
| 9: | pos(p_{wl}) = [h₃(seed)mod (H − n), h₄(seed)mod(W − n)] |
| 10: | x_{wl} = (Tₓ)⁻¹[((Tₓ)(xₗ))⊕p_{wl})] |
| 11: | seed = h₀(seed) |
| 12: | End of Loop |

Referring to Table 3, for individual training samples xₗ in X, the exemplary Transform(·) function implementation applies five hash functions h₀, h₁, h₂, h₃, h₄ to generate a specific pattern of the ownership watermark including: a watermarking mask pattern p_{w} and a watermarking classification label yw for embedding. The hash functions can be any secure hash function, for example, SHA-256. The five hash functions may be applied to each individual training sample xₗ which may be an image having a height H and a width W. A first hash function h₀ may be used to generate a seed value based on the signature sig. A second hash function h₁ may be used to generate the watermarking classification label y_{wl} (i.e., the misidentifying or “false” label) for embedding. A third hash function h₂ may be used to generate a watermarking mask pattern p_{wl} (i.e., the watermarking pattern). A fourth and fifth hash functions h₃ and h₄ may be used to generate a position within the training sample xₗ to add the watermarking mask pattern p_{wl}. The watermarking mask pattern p_{wl} is combined (e.g., via binary addition or XOR) with the individual training sample xₗ.

Referring to line 11 in Table 3, the first hash function h₀ may be used to generate a second seed value based on the first seed value. Additionally or alternatively, a subsequent seed value may be generated based on a hash of the signature and a respective random number associated with a respective training sample.

Additionally or alternatively, the training sample xₗ may be transformed into a different domain, combined (e.g., binary addition) with the watermarking mask pattern p_{wl} and the modified training sample is transformed back. Additionally or alternatively, any number of hash functions may be used.

In some embodiments, the mask pattern p_{wl} may contain a single white/black pixel area of size n*n. In such embodiments, the watermark mask pattern p_{wl} can be represented by the bit pattern bit (p_{wl}) in the white/black square and the top-left pixel position of the white/black square may be arbitrarily arranged at pos(p_{wl} ) based on the seed value.

When the length of the watermark bit pattern or string Nₚ in bit (p_{wl}) or mask pattern p_{wl} is reasonably small, the embedding of p_{w} into an image produces no change in visual effect.

Also, when the length of the watermark bit pattern or string Nₚ in bit (p_{wl}) or mask pattern p_{wl} is reasonably small, the embedding p_{wl} into a model does not affect the model's normal classification accuracy.

Additionally or alternatively, the generated watermarking mask pattern p_{wl} may be noises applied to an image xₗ via transformation (Tₓ) in any of the 3 domains: time, frequency, time frequency, then transform back via reverse-transformation (Tₓ)⁻¹ to a visually indistinguishable image with p_{wl} embedded in image xₗ.

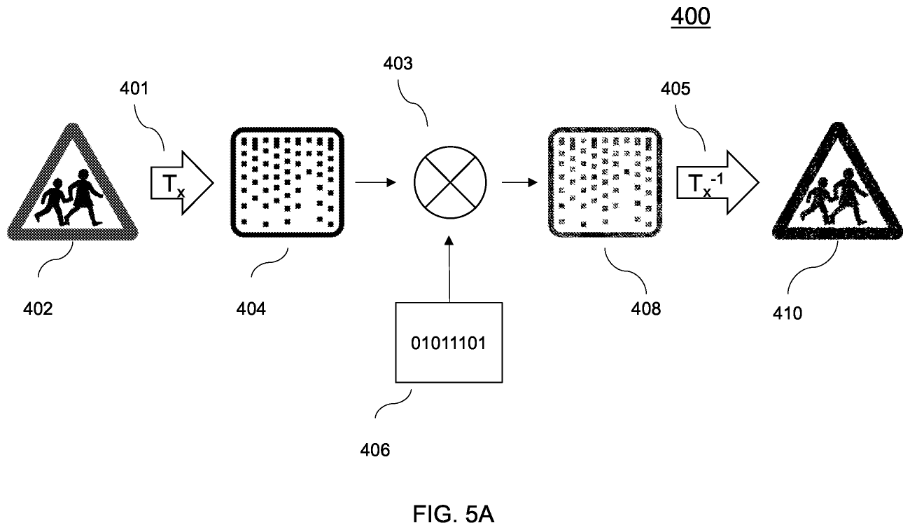

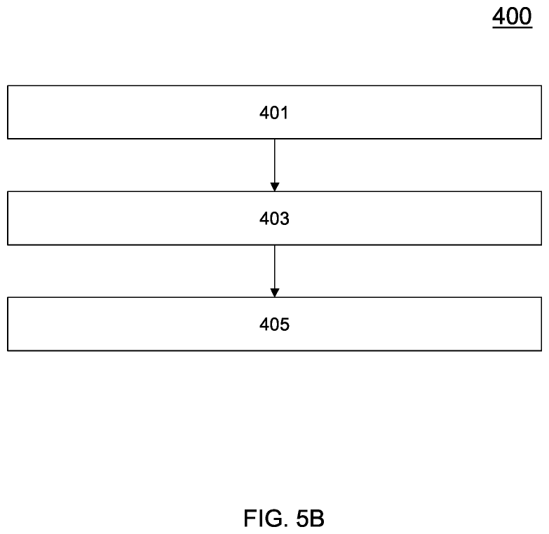

FIGS. 5A-B illustrate a simplified block diagram and a simplified flow diagram of the watermark pattern encoding process 400 including a transformation and reverse-transformation in the secured watermark encoding phase 100 according to various further embodiments of the present disclosure, which may be combined with any exemplary embodiment as described above and the further embodiments described above or below. A watermarking mask pattern p_{wl} 406 may be encoded into a training sample image xₗ 402 to generate a watermarked training sample image xw\ 410 (i.e., a dummy training sample image).

At 401, one or more processors may transform a training sample from a first domain to a second domain. A transformation (Tₓ) is applied to training sample image xₗ 402 to transform the training sample image xₗ 402 from a first domain to a different second domain 404, e.g., from spatial domain to a time, frequency, or time frequency domain.

At 403, one or more processors may combine or encode a watermark mask pattern into the transformed training sample in the second domain. A watermarking mask pattern p_{wl} 406 may be encoded or combined with the transformed training sample image (Tₓ)(xₗ) to generate a watermarked training sample (Tₓ)(x_{wl}) 408 in the second domain.

At 405, one or more processors may inverse transform the watermarked training sample in the second domain to generate a hidden watermarked training sample in the first domain. An inverse or reverse-transformation (Tₓ)⁻¹ is applied to the watermarked training sample image (Tₓ)(x_{wl}) 408 in the second domain to generate a watermarked training sample image x_{wl} 410 in the first domain with a hidden watermark.

To forge an owner's watermark, the attacker must either forge the owner's encrypted information (e.g., a cryptographic signature) or randomly produce encrypted information (e.g., a cryptographic signature) whose hash produces the characteristics, i.e. reverse a string, one-way hash. Both are known to be computational infeasible under reasonable resource assumptions.

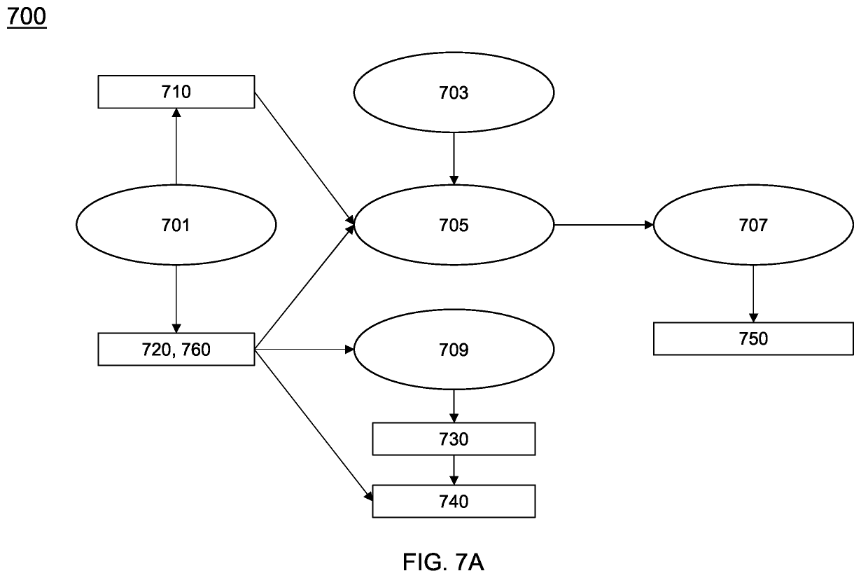

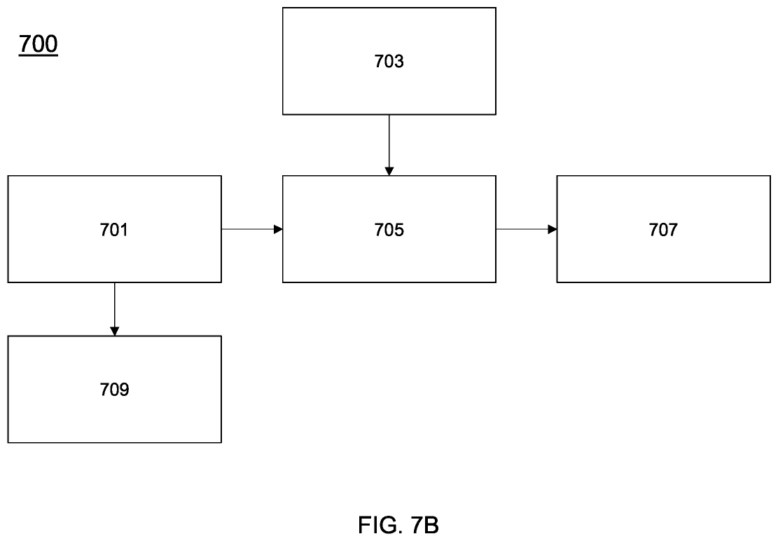

FIGS. 7A-7B illustrates more detailed block and flow diagrams of the encoding phase 700 according to other various further embodiments of the present disclosure, which may be combined with any exemplary embodiment as described above and the further embodiments described above or below.

Referring to FIGS. 7A-7B, the encoding phase 700 may include generating a digital signature 730 based on verifier data 720 and generating a trigger set 750 based on the verifier data 720 (i.e., information used to generate the digital signature). A certificate 740 including a digital signature 730 may be generated for each training sample selected for watermarking 710.

At 701, one or more processors may be configured to receive owner input including at least one training sample for watermarking 710 (e.g., selected subset of normal training samples) and verification data 720 including pre-defined watermark classification labels 760 for each of the received training samples for watermarking. That is, owner input for generating watermarking information is received. The owner input may include a selected subset of training samples for watermarking (e.g., at least one, preferably a plurality). The verification data 720 may also include identification information of the owner. The owner's identification information may be a unique owner ID. The owner input may also include a global timestamp, an expiration date, etc.

For each training sample in the selected subset, a corresponding watermark classification label is received. The watermark classification label for each training sample may be pre-determined or pre-defined by the owner and included in the owner input provided by the owner. The watermark classification label should be unique to each training sample in the selected subset. For example, according to various further embodiments of the present disclosure, which may be combined with any exemplary embodiment as described above and the further embodiments described above or below, the owner may provide or define a distinct watermark classification label for each training sample in the selected subset (e.g., an image of a vehicle with a watermark pattern is labeled as a ship; an image of a person with a watermark pattern is labeled as a dog). Different owners may provide different watermark classification labels. Accordingly, ownership of the model may be possible based on the arbitrary choice, assignment, and/or association of watermark classification labels.

At 703, one or more processors may generate a random number (RN) for each received training sample. A random number generator may generate a random number for each training sample of the selected subset of training samples.

At 705, one or more processors may generate a respective watermark pattern based at least on the corresponding watermark classification label 760 for each received training sample. The watermark classification label 760 is included in the verification data 720. The watermark pattern may additionally be generated based on the corresponding random number and additional information included in verification data 720 (e.g., identification information of the owner). For each training sample in the selected subset, a watermark pattern is generated. A unique watermark pattern for each training sample may be generated based on the corresponding watermark classification label, the owner's identification information (e.g. owner ID), and/or the random number. For example, according to various further embodiments of the present disclosure, which may be combined with any exemplary embodiment as described above and the further embodiments described above or below, for each training sample in the selected subset, the corresponding watermark classification label defined for the training sample may be provided to one or more hash functions to generate (to be transformed into) a respective watermark pattern for the training sample. That is, a transform or hash function may modify the watermark classification label into a watermarking pattern. In some further embodiments of the present disclosure, which may be combined with any exemplary embodiment as described above and the further embodiments described above or below, the random number generated for the training sample and/or the owner's identification information (e.g., owner ID) may be combined with the corresponding watermark classification label and provided to one or more hash functions to generate (to be transformed into) a respective watermark pattern for the training sample.

At 707, one or more processors may combine the corresponding watermark pattern with the corresponding training sample for each received training sample. The one or more processors may assign the corresponding pre-defined watermark classification label. For each training sample in the selected subset, the corresponding generated watermark pattern is combined with or encoded into the corresponding training sample. The watermark pattern may be combined with the corresponding training sample for example by binary addition in a first domain or a second domain. Each watermarked training sample and corresponding watermark classification label form a trigger set 750 used to train the DNN model along with the normal set of training data.

At 709, one or more processors may generate an encrypted value 730 (e.g., digital signature) based at least on the corresponding watermark classification label 760 (i.e., included as information used to generate the encrypted value 730) for each received training sample. The encrypted value 730 may be generated using a public key signature scheme. For example, an encrypted value (digital signature) 730 may be generated based on the owner's private key 725 and the corresponding pre-defined watermark classification label 760. The encrypted value 730 and the corresponding pre-defined watermark classification label 760 may be included in a certificate 740. The verification data 720 includes the watermark classification label 760. For example, according to various further embodiments of the present disclosure, which may be combined with any exemplary embodiment as described above and the further embodiments described above or below, the watermark classification label may be hashed to generate a tag value. The hash may be a hash operation used for public key signature schemes. The respective tag value is signed (i.e., encrypted) using the owner's private key to generate a signature associated with the verifier data of a respective watermarked training sample. The certificate includes the verifier data and the digital signature. The certificates may be provided with the neural network model. For each training sample in the selected subset, a certificate 740 is generated. In some further embodiments of the present disclosure, which may be combined with any exemplary embodiment as described above and the further embodiments described above or below, the corresponding watermark classification label, the corresponding random number, and ownership information may be used as verifier data for generating the digital signature 730 included in the certificate 740. For example, according to various further embodiments of the present disclosure, which may be combined with any exemplary embodiment as described above and the further embodiments described above or below, the watermark classification label, the random number may, and ownership information may be hashed to generate a tag value. The hash may be a hash operation used for public key signature schemes. That is, the watermark classification label defined for the training sample, the random number generated for the training sample, and the owner ID may be combined (e.g., concatenated into a bit string) and provided to a hash function to generate a tag value. The respective tag value is signed (i.e., encrypted) using the owner's private key to generate a signature associated with the verifier data of a respective watermarked training sample. The certificate includes the verifier data and the signature. The certificates may be provided with the neural network model.

In various embodiments, the watermark encoding phase 700 takes as input: a random number, training samples X^{l} for watermarking, corresponding pre-determined watermark classification labels (Y_{w}^{l}), a verifier string (including owner input, e.g., an owner's unique identifier, a global timestamp, and/or an expiry date), and an owner's private key. The training samples X^{l} may be a preselected subset of training samples chosen from the normal set of training samples X^{L}. The watermark encoding phase provides as output: a trigger set including watermarked training samples (X_{w}^{l}) and corresponding watermark classification labels (Y_{w}^{l}) for embedding, where l (the number of training samples for watermarking) is less than L (the total number of training samples for the model).

TABLE 4
Generating Ownership Watermark

| Input: | Pre-selected subset of training samples X^{l} for watermarking, | |
|---|---|---|
| | corresponding pre-determined watermark classification | |
| | labels (Y_{w}^{l}), verifier string (owner input, including, e.g., | |
| | owner's unique identifier, watermark classification label | |
| | y_{wl}, global timestamp, expiry date), owner's private key, | |
| | random number | |
| Output: | Watermarked training samples (X_{w}^{l}) and corresponding | |
| | watermark classification labels (Y_{w}^{l}) | |
| 1 | sig = SIGN (Oₚᵣᵢ, v) | Eq. 1 |
| 2 | (X_{w}^{l}, Y_{w}^{l}) = Transform(Y_{w}^{l}, X_{w}^{l}) | Eq. 3 |

Referring to Table 4, the generation of an ownership watermark may include generating a signature sig based on one or more of the pre-determined watermark classification labels (Y_{w}^{l}) and also modifying a subset of training samples X^{l} to generate a set of watermarked training samples (X_{w}^{l}) based on the corresponding pre-determined watermark classification labels (Y_{w}^{l}).

For each training sample in X^{l}, the owner applies a SIGN(·) function to produce signature sig. The SIGN(·) function takes as input the owner's private key Oₚᵣᵢ and a verifier string v, then provides as output the signature sig. The verifier string may be a string concatenation of the owner's unique identifier and a watermark classification label y_{wl}. The verifier string may include a global timestamp. The global timestamp facilitates timestamp checking to prevent man in the middle attacks. The verifier string may also include an expiry date. The SIGN(·) function may be implemented using a common public key signature scheme. The verifier string may also include a random number. In this case, the SIGN(·) function may take as input a random number or generate a random number. Each time the random number generated is different, this is the vector that differentiates according to timing etc. Thus, the signatures for each trigger set is different. In some embodiments, a signature may be generated for each watermark classification label y_{wl} in the set of pre-determined watermark classification labels (Y_{w}^{l}). In some embodiments, one signature may be generated for the set of pre-determined watermark classification labels (Y_{w}^{l}).

The owner uses the pre-defined watermark classification labels (Y_{w}^{l}) for the selected training samples to generate the watermark patterns for the selected training samples. The owner may apply a Transform(·) function to a preselected subset of training samples X^{l} to generate watermarked versions of the preselected subset of training samples X_{w}^{l}. The Transform(·) function may take as input the watermark classification labels (Y_{w}^{l}), the random numbers, and a preselected subset of training samples X^{l} for watermarking, then may provide as output the trigger set, e.g., watermarked training samples (X_{w}^{l}) paired to corresponding watermark classification labels (Y_{w}^{l}). The Transform(·) function may be implemented using one or more one-way hash functions for generating watermarked training samples. The random number may be used to generate a different watermark pattern for each training sample so that each training sample may be encoded with a different watermark pattern.

Table 5 shows an example of another Transform(·) function in accordance with various further embodiments of the present disclosure, which may be combined with any exemplary embodiment as described above and the further embodiments described above or below. The watermark encoding phase 100, 700 provides as output: watermarked training samples (X_{w}^{l}) and corresponding watermark classification labels (Y_{w}^{l}). The watermark classification labels should be different than the normal classification labels corresponding to the unwatermarked versions of the training samples. That is, a watermark classification label should not actually or correctly identify a watermarked training sample (e.g., it should be misidentifying or a “false” label). The watermark classification label may be an arbitrarily generated or predetermined and assigned to the watermarked training sample. The intentional misidentification is used as a fingerprint to facilitate detection of modifications made to a model.

TABLE 5
Example of Transform (.) function: (X_{w}^{l}, Y_{w}^{l}) = Transform(Y_{w}^{l}, X^{l})

| Input: | Preselected subset of training samples (X^{l}) for watermarking |
|---|---|
| | and watermark classification labels (Y_{w}^{l}) |
| Output: | Paired watermarked training samples (X_{w}^{l}) and watermark |
| | classification labels (Y_{w}^{l}) (e.g., trigger set) |
| 1: | l = total number of training samples X^{l} to be watermarked |
| 2: | Y = total number of model classes (e. g., classification |
| | identifiers) |
| 3: | Loop through xₗ in X^{l} |
| 4: | H = height of input xₗ |
| 5: | W = width of input xₗ |
| 6: | seed = h₅(y_{wl}) |
| 7: | bit(p_{wl}) = h₆(seed)mod 2ⁿ² |
| 8: | pos(p_{wl}) = [h₇(seed)mod (H − n), h₈(seed)mod(W − n)] |
| 9: | x_{wl} = (Tₓ)⁻¹[((Tₓ)(xₗ))⊕p_{wl})] |
| 10: | End of Loop |

Referring to Table 5, for individual training samples xₗ in X^{l}, the exemplary Transform(·) function implementation applies four hash functions h₅, h₆, h₇, h₈ to generate a specific pattern of the ownership watermark including: a watermarking mask pattern p_{w} for encoding. The hash functions can be any secure hash function, for example, SHA-256. The four hash functions may be applied to each individual training sample xₗ which may be an image having a height H and a width W. A first hash function h₅ may be used to generate a seed value based on the watermark classification label y_{wl} (i.e., the misidentifying or “false” label) for embedding. A second hash function h₆ may be used to generate a watermarking mask pattern p_{wl} (i.e., the watermarking pattern) based on a seed value generated from the watermark classification label. The third and fourth functions h₇ and h₈ may be used to generate a position within the training sample xₗ to add the watermarking mask pattern p_{wl}. The watermarking mask pattern p_{wl} is combined (e.g., via binary addition or XOR) with the individual training sample xₗ.

Additionally or alternatively, the seed value may be generated based on a random number.

Additionally or alternatively, the training sample xₗ may be transformed into a different domain, combined (e.g., binary addition) with the watermarking mask pattern p_{wl} and the modified training sample is transformed back. Additionally or alternatively, any number of functions may be used.

In some embodiments, the mask pattern p_{wl} may contain a single white/black pixel area of size n*n. In such embodiments, the watermark mask pattern p_{wl} can be represented by the bit pattern bit (p_{wl}) in the white/black square and the top-left pixel position of the white/black square may be arbitrarily arranged at pos(p_{wl}) based on the seed value.

When the length of the watermark bit pattern or string Nₚ in bit(p_{wl}) or mask pattern p_{wl} is reasonably small, the embedding of p_{wl} into an image produces no change in visual effect.

Also, when the length of the watermark bit pattern or string Nₚ in bit(p_{wl}) or mask pattern p_{wl} is reasonably small, the embedding p_{wl} into a model does not affect the model's normal classification accuracy.

Additionally or alternatively, the generated watermarking mask pattern p_{wl} may be noises applied to an image xₗ via transformation (Tₓ) in any of the 3 domains: time, frequency, time frequency, then transform back via reverse-transformation (Tₓ)⁻¹ to a visually indistinguishable image with p_{wl} embedded in image xₗ.

In the watermark embedding phase 200, the training samples along with their corresponding respective assigned classification/identification labels are added to the real training samples with actual classification/identification labels so as to be ingested by the model. Upon model training, a watermark is successfully embedded into the model only if for each watermarked training sample in the trigger set, when queried returns the assigned pre-determined watermark classification label. That is, F_{θ} iff

$${F}_{θ} ( {x}_{w} ) = {y}_{w} , ∀ {x}_{w} ∈ {ℝ}^{N} , {y}_{w} ∈ {ℝ}^{M}$$

where y_{w} is the assigned identification label of x_{w}.

That is, the owner generates watermarked training data including watermarked training samples and corresponding assigned watermark classification labels. The owner then combines the watermarked training data with its original training data and uses loss-based optimization methods to train the model while injecting the watermarked training data. The objective function for model training is defined as:

$$arg {min}_{θ} [ {ℓ}_{F} ( x , y ) + α * {ℓ}_{F} ( {x}_{w} , {y}_{w} ) ] \qquad Eq . 4$$

where y is the true label for input training sample x, y_{w} is the assigned misidentifying label for watermarked training sample x_{w}, and [symbol] _{F}(·) is the loss function for measuring the classification error (e.g. cross entropy) and a is the injection rate for the watermark embedding.

In the watermark authentication phase, first the information provided by the owner (i.e., owner input) to generate the trigger training set is verifiable by signature of the owner using a public cryptographic key. Second, a watermarked training sample generated based on the verified watermark classification label is used to generate a query to the DNN so that a standard inference task based on the derived label from input can be used to verify the integrity of the model. That is, ownership of the model is indicated where the predetermined corresponding output labels of the trigger training set have a matching relationship to the inferred labels outputted from querying the model with watermarked dummy training samples.

The embodiment described herein may reuse cryptographic functions based on Hardware Security Module (HSM) as most of MCU is embedded with HSM module, e.g. random number generation, encryption/decryption.

The watermark authentication phase includes verifying the certificate including the signature and the verification data, generating or obtaining a trigger set (X_{w}^{l}, Y_{w}^{l}) using the verified certificate, querying the model using at least one of the watermarked training samples to extract a respective watermark classification label for each respective watermarked training sample, comparing the extracted watermark classification label to the generated watermark classification label for each respective watermarked training sample used as a query. If the extracted watermark classification label and the generated watermark classification label are the same, then the model has not likely been tampered with.

In the watermark authentication phase 300, the embedded assigned watermark classification labels are extracted and verified. The performance of the watermark may be evaluated using two metrics: normal classification accuracy and watermark classification accuracy. The normal classification accuracy is the classification accuracy of trigger set which is the probability that the classification result of any normal input training sample x equals its true classification label y, i.e. Pr(F_{θ}(x)=y). The watermark classification accuracy is the classification accuracy of the trigger set, which is the probability that the classification result of any watermarked training sample x_{w} equals its assigned (e.g., “false”) watermark classification label y_{w}, i.e., Pr(F_{θ}(x)=y_{w}).

TABLE 6
Verification of ownership watermark

| | |
|---|---|
| 1: | If not Verify (O_{pub,} Sig, v) then |
| 2: | Verification Failed. |
| 3: | else |
| 4: | (X_{w}^{l}, Y_{w}^{l}) = Transform(.) |
| 5: | Ø = Pr (F_{θ}(X^{l}_{w}) = Y_{w}^{l}) |
| 6: | If Ø > T_{watermark} then |
| 7: | Verification Passed. |
| 8: | Else |
| 9: | Verification Failed. |
| 10: | end if |
| 11: | end if |

The watermark authentication (or verification) phase includes two stages. First, a certificate of the model F_{θ} which uniquely links the signature to the owner of the model is verified. That is, the validity of the signature sig over the verifier string v generated by the private key of the owner associated with O_{pub} is determined. Second, whether the owner's watermark is defined by the certificate is injected into the model F_{θ}.

In the first stage, a third-party (e.g., a user or a trusted authority) authenticates a certificate of the model. That is, the third-party verifies the signature sig is a valid signature over the verifier string v generated by the private key associated with O_{pub}. The owner's private uniquely links the signature to the owner. Second, if the certificate is verified, the third-party checks whether a watermark defined by the certificate (either by sig or by verifier data) is injected into the model F_{θ}. If the certificate is not verified, the authentication phase may end and does not proceed to the second stage.

The “claimed” owner submits its signature sig, public key O_{pub}, and verifier string v to the third-party for a target model F_{θ}, the third-party may run the algorithm of Table 6 to verify whether the owner has its ownership watermark embedded in the target model F_{θ}, under the assumption that the third-party has access to the Transform(·) function used by the owner to generate the watermark training data based on the certificate (either the signature sig or the verification information used to generate the signature).

The “claimed” owner may provide the third-party access to its Transform(·) function for the target model F_{θ} via a black box interface such as access via an application programmer interface (API). The black box may include the selected subset of training samples X^{l} and need only receive the “claimed” owner's signature or verification information of the verified certification as input to perform the Transform(·) function to generate a trigger set including watermarked versions of the normal training samples and corresponding watermark classification labels (line 4 of Table 6). In some embodiments, the third-party passes the signature sig to the black box interface to run Transform(sig·X^{l}) to generate a trigger set. In some embodiments, the third-party passes at least one watermark classification label y_{wl} to the black box interface to run Transform (Y_{w}^{l}·X^{l}) to generate a trigger set. The third-party receives the trigger set for use to verify ownership of the neural network model.

Based on the trigger set, the third-party forms a test input set and computes the classification accuracy of the watermark embedding (line 5 of Table 6). The classification accuracy of the watermark embedding measures how successful the watermarked training samples were injected into the neural network model. If the accuracy exceeds a threshold T_{watermark}, the third-party concludes that the owner's watermark is present in the model, thus ownership verification succeeds.

The classification accuracy threshold may be set at 90%. In some case, the classification accuracy threshold may be set at 80%. The classification accuracy threshold may vary depending on the total number of watermarked training samples in the trigger set and the number of watermarked training samples in the trigger set used for querying the DNN model. When the trigger set includes a small number of watermarked dummy training samples, the classification accuracy threshold may be high (e.g., 90%). When the trigger set includes a large number of watermarked dummy training samples, the classification accuracy may be lower (e.g., 80%).

In some embodiments, the watermark authentication phase may be a process of private verification where user relies on a third-party verifier who is a trusted authority, who keeps the verification process completely private with no leakage of any information. In some embodiments, the watermark authentication phase may be a process of partial private verification where a user may verify a certificate of the model and request at least one pair of a trigger set based on the verified certificate (e.g., either the verified signature or verified information used to generate the signature). The trigger set generation process is completely private with no leakage of any information. The trigger set generation may be performed by the owner or a trusted authority.

In a private verification process, the certificate including the signature is only provided to a third party that is a trusted authority and not a user with the assumption that the trusted authority will not leak the signature sig.

The private verification assumes the authority can be trusted not sharing information about the owner signature and the trigger set. However, if the signature is leaked to an adversary, who attempts to modify or corrupt the watermark by applying a small amount of training to change the classification outcome of the watermark model-embedding, that leads to corruption attack where the ownership watermark is no longer verifiable.

In the presence of authoritative third-party certifier, simply embedding new watermarks, i.e., p′ (p′≠p_{wl}) is not enough as successful attack.

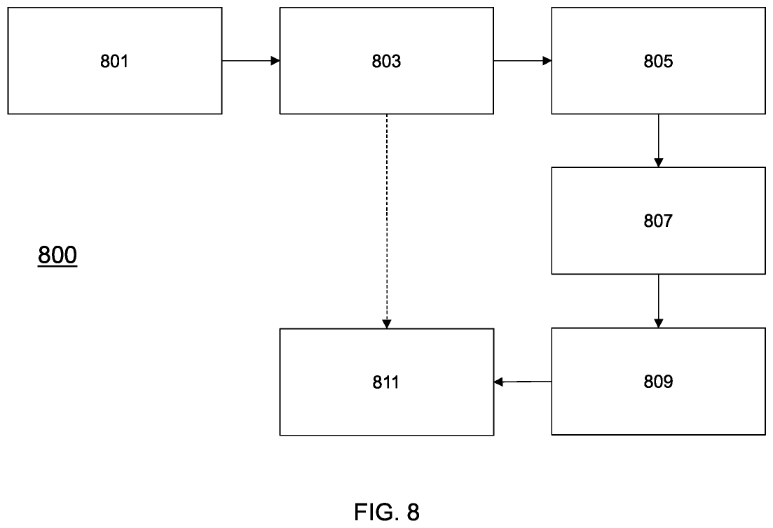

FIG. 8 illustrates a simplified flow diagram of authenticating phase 800 for use with encoding phase 600.

A certificate is received with the neural network model, a third-party desiring to authenticate the neural network may first verify the certificate including the signature and the verifier data. The verification is based on a public key signature scheme. If the signature is verified, the signature may be used to generate queries for the neural network model. The owner of the neural network may provide access to a black box (e.g., via an application programmer interface API) that takes as input the verified signature and generates as output a set of watermarked training samples for the query and corresponding watermark classification labels for verification. The third-party may receive the watermarked training sample-watermark classification label pairs from the black box and use it to query the neural network model. The neural network model will provide as output extracted classification labels when queried. If the extracted classification labels and the watermark classification labels received from the black box are the same, then the neural network model may belong to the owner. Referring to the example above, if the extracted classification label is “ship” for an image of a vehicle with watermark and the received watermark classification label for the watermarked image is also “ship”, the authenticator may conclude that the neural network model belongs to the owner. For example, according to various further embodiments of the present disclosure, which may be combined with any exemplary embodiment as described above and the further embodiments described above or below, the authenticator may only conclude that the neural network model belongs to the owner if the number of matches exceed a pre-determined threshold.

Referring to FIG. 8, at 801, one or more processors may receive a neural network model and a certificate associated with the model. A neural network model and a certificate associated with the neural network model is received by a third-party. The certificate may include the owner's digital signature and verifier data including owner information.

At 803, one or more processors may verify the signature and the verifier data. The certificate including the digital signature and verifier data may be verified. The verification may be based on a public key signature scheme. For example, the signature may be decrypted using the owner's public key to obtain a decrypted tag value. The verifier data may be transformed using a hash operation associated with the public key signature scheme to generate a tag value. If the decrypted tag value and the generated tag value are the same, then the signature and verifier data may be verified.

At 805, one or more processors may request a trigger set (watermarked training samples and watermark classification labels) based on the verified signature. If the certificate is verified, watermarked training samples generated based on the verified signature are requested. The owner of the neural network model may provide access to a black box for generating watermarked training samples based on the signature. The black box may be accessed via an application programmer interface (API). The black box may be a processor with storage and a communication interface. The black box may take as input the verified signature and generate one or more watermarked training samples in accordance with the process described in the encoding phase 600. For example, according to various further embodiments of the present disclosure, which may be combined with any exemplary embodiment as described above and the further embodiments described above or below, the signature, the random number, and the owner ID may be combined (e.g., concatenated) and provided to one or more hash functions to generate (to be transformed) into one or more watermark patterns. Each watermark pattern is combined or encoded (e.g., binary addition) with a corresponding training sample to generate a watermarked training sample.

At 807, one or more processors may receive a trigger set including one or more watermarked training samples and watermark classification labels. One or more watermarked training samples generated based on the verified signature is received.

At 809, one or more processors may query the neural network model using at least one of the received watermarked training samples to obtain extracted watermark classification labels. At least one of the received watermarked training samples is used to query the AI model (e.g., DNN) to obtain an extracted/queried watermark classification label corresponding to the watermarked training sample. Preferably, a plurality of received watermarked training samples are used to query the AI model to obtain a plurality of classification labels corresponding respectively to the plurality of watermarked training samples.

At 811, one or more processors may compare at least one of the received watermark classification labels with at least one of the extracted watermark classification labels. If they match, then the neural network model may not have been tampered with. Preferably, a plurality of the received watermark classification labels are compared with a plurality of the extracted watermark classification labels. If the number of matches exceeds a pre-determined threshold (e.g., 90% of the comparisons match), then the neural network model is unlikely to have been tampered with.

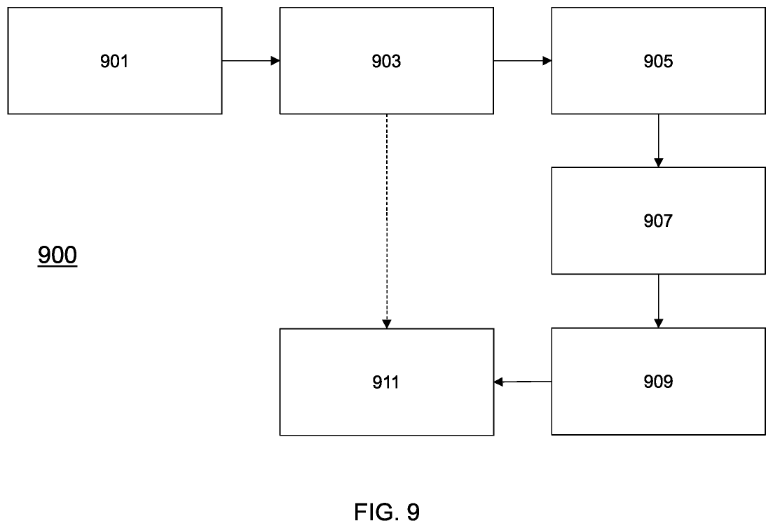

FIG. 9 illustrates a simplified flow diagram of authenticating phase 900 for use with encoding phase 700.

For each certificate received with the neural network model, a third-party desiring to authenticate the neural network may first verify the certificate including the signature and the verifier data. The verification is based on a public key signature scheme. If the signature is verified, the verifier data (e.g., including a pre-defined watermark classification label) included in the certificate may be used to generate a query for the neural network model. The owner of the neural network may provide access to a black box (e.g., via an application programmer interface API) that takes as input the verified verifier data and generates as output a watermarked training sample for the query. The third-party may receive the watermarked training sample from the black box and use it to query the neural network model. The neural network model will provide as output an extracted classification label when queried. If the extracted classification label and the watermark classification label included in the verifier data are the same, then the neural network model may belong to the owner. Referring to the example above, if the extracted classification label is “ship” for an image of a vehicle with watermark and the owner assigned watermark classification label included in the verifier data for the watermarked image is also “ship”, the authenticator may conclude that the neural network model belongs to the owner. For example, according to various further embodiments of the present disclosure, which may be combined with any exemplary embodiment as described above and the further embodiments described above or below, the third-party (user or trusted authority) may only conclude that the neural network model belongs to the owner if the number of matches exceed a pre-determined threshold. That is, the authenticator may verify a plurality of certificates, request a plurality of watermarked training samples generated based on the plurality of verified watermark classification labels included in the plurality of certificates, query the neural network model using the received plurality of watermark training samples, obtaining a plurality of extracted watermark classification labels, comparing the plurality of verified watermark classification labels with the plurality of extracted watermark classification labels, and determining the neural network model belongs to the owner when the number of matches of the comparisons exceed a pre-determined threshold (e.g., 90% of the comparisons).

Referring to FIG. 9, at 901, one or more processors may receive a neural network model and at least one certificate associated with the model. A neural network model and at least one certificate associated with the neural network model is received by a third-party. Each certificate may include the owner's digital signature and verifier data corresponding to a respective watermarked training sample embedded in the neural network model. The verifier data may include a watermark classification label corresponding to the watermarked training sample, a random number corresponding to the watermarked training sample, and an owner ID.

At 903, one or more processors may verify the signature and the verifier data for each of the at least one certificate. For each certificate, the digital signature and the verifier data may be verified. The verification may be based on a public key signature scheme. For example, the signature may be decrypted using the owner's public key to obtain a decrypted tag value. The verifier data (e.g., including a pre-defined watermark classification label) may be transformed using a hash operation associated with the public key signature scheme to generate a tag value. If the decrypted tag value and the generated tag value are the same then the signature and verifier data including the watermark classification label may be verified.

At 905, one or more processors may request a watermarked training sample based on the verifier data for each certificate. For each verified certificate, a watermarked training sample based on the verified verifier data including the pre-defined watermark classification label is requested. The owner of the neural network model may provide access to a black box for generating watermarked training samples based on verifier data. The black box may be accessed via an application programmer interface (API). The black box may be a processor with storage and a communication interface. The black box may take as input the verifier data and generate a watermarked training sample in accordance with the process described in the encoding phase 700. For example, according to various further embodiments of the present disclosure, which may be combined with any exemplary embodiment as described above and the further embodiments described above or below, the watermark classification label, the random number, and the owner ID may be combined (e.g., concatenated) and provided to one or more hash functions to generate (to be transformed) into a watermark pattern. The watermark pattern is combined or encoded (e.g., binary addition) with a corresponding training sample to generate a watermarked training sample.

At 907, one or more processors may receive a watermarked training sample for each verified certificate. For each verified certificate, a watermarked training sample based on the verified verifier data (e.g., pre-defined watermark classification label) is received.

At 909, one or more processors may query the neural network model using the watermarked training sample to obtain an extracted watermark classification label for each verified certificate. For each verified certificate, the received watermarked training sample is used to query the AI model (e.g., DNN) to obtain an extracted/queried watermark classification label corresponding to the watermarked training sample.

At 911, one or more processors may compare the verified watermark classification label with the extracted watermark classification label for each verified certificate. For each verified certificate, the verified watermark classification label is compared with the extracted watermark classification label. If they match, then the neural network model is unlikely to have been tampered with. Preferably, a plurality of the verified watermark classification labels are compared with a plurality of the extracted watermark classification labels. If the number of matches exceeds a pre-determined threshold (e.g., 90% of the comparisons match), then the neural network model is unlikely to have been tampered with.

The watermarked training samples do not affect the accuracy of detection rate of the current AI model. In addition, it can provide authentication and ownership for the users to use this model.

The embodiments described herein may be scalable and flexible and can be implemented using a software only solution.

The processing means may include one or more processors and a memory operatively coupled to the one or more processors. The memory may include or may be configured as a read-only memory (ROM) and/or a random-access memory (RAM), or the like.

### EXAMPLES

Example 1 is a method of providing a secured watermark to a neural network model, including: receiving a training sample for watermarking; receiving verification data about the neural network; generating a digital signature based at least on the verification data; generating a certificate for the neural network model, the certificate including the digital signature and the verification data used in the generation of the digital signature; generating a watermark pattern based on the certificate; combining the watermark pattern with the training sample to generate a watermarked training sample; pairing the watermarked training sample with a watermark classification label; and providing to the neural network model the paired watermarked training sample and watermark classification label for training.

Example 1A is a method according to Example 1, wherein a trigger set includes the watermarked training sample and the watermark classification label.

Example 2 is a method according to Example 1, further including: generating the watermark pattern based on the digital signature; and generating the watermark classification label based on the digital signature.

Example 3 is a method according to Examples 1 or 2, wherein the digital signature is generated by encrypting the verification data using a private key of an owner of the neural network model, wherein the verification data is a verifier string including ownership information.

Example 4 is a method according to Example 3, wherein the digital signature is a bit-string used as a seed value for one-way hashing.

Example 5 is a method according to Example 4, wherein the verifier string further includes a random number.

Example 6 is a method according to Examples 4 or 5, wherein generating the watermark classification label and generating the watermark pattern further includes: performing a one-way hash operation on the digital signature to generate the seed value; generating the watermark classification label based on a first one-way hash operation on the seed value; and generating the watermark pattern based on a second one-way hash operation on the seed value.

Example 7 is a method according to Example 6, wherein the training sample is an image and combining the watermark pattern with the training sample to generate the watermarked training sample further comprises; performing third and fourth one-way hash operations on the seed value to generate a position of the watermark pattern relative to a height and width of the training sample.

Example 8 is a method according to Example 1, further including: receiving the watermark classification label; and generating the watermark pattern based on the watermark classification label.

Example 9 is a method according to Example 8, wherein the digital signature is generated by encrypting the verification data using a private key of an owner of the neural network model, wherein the verification data is a verifier string including the ownership information and the watermark classification label.

Example 10 is a method according to Example 8 or 9, wherein the watermark pattern is generated based on a one-way hash operation on the watermark classification label and a random number.

Example 11 is a method according to any one of Examples 8-10, wherein the watermark classification label is predetermined by an owner of the neural network model.

Example 12 is a method according to any one of Examples 1-11, wherein combining the watermark pattern with the training sample to generate the watermarked training sample further includes: transforming the training sample from a first domain to a second domain; combining the watermark pattern to the training sample in the second domain to generate a watermarked training sample in the second domain; and inverse transforming the watermarked training sample in the second domain to generate a watermarked training sample in the first domain.

Example 13 is a method according to any one of Examples 1-12, further including: receiving a classification label for the training sample; and providing the training sample and the classification label as input to train the neural network.

Example 14 is a method according to Example 13, wherein the training sample and the classification label comprise one pair of a plurality of pairs of normal training data provided to the neural network; and the paired watermarked training sample and the watermarked classification label comprise one pair of a plurality of pairs of watermarked training data provided to the neural network to inject a watermark, wherein the classification label and the watermarked classification label are different.

Example 15 is a method of verifying a secured watermark generated or generatable by a method according to any one of Examples 1-14, including: receiving a neural network model; receiving a certificate of the neural network model including a verification data and a digital signature of the owner of the neural network; verifying the certificate of the owner using a public key of the owner; receiving a paired watermarked training sample and watermark classification label generated based on the verified digital signature or the verification data;
querying the neural network model using the watermarked training sample;
receiving an output classification label based on the query; comparing the output classification label with the watermark classification label; determining the neural network model belongs to the owner when the output classification label and the watermark classification label are the same.

Example 16 is a method of Example 15, further including: receiving a plurality of paired watermarked training samples and watermark classification labels generated based on the verified digital signature or the verification data; querying the neural network model using the plurality of watermarked training samples; receiving a plurality of output classification labels based on the queries; comparing the respective output classification labels and watermark classification labels; determining the neural network model belongs to the owner when a percentage of the output classification label and the watermark classification label matching exceeds a predetermined threshold.

Example 17 is a data structure generated by performing the method according to any one of claims 1-14.

Example 18 is a computer program product comprising instructions which, when the program is executed by a computer, cause the computer to carry out the method of any one of claims 1-16.

1. A computer-implemented method of providing a secured watermark to a neural network model, comprising:
receiving a training sample for watermarking;
receiving verification data about the neural network;
generating a digital signature based at least on the verification data;
generating a certificate for the neural network model, the certificate including the digital signature and the verification data used in the generation of the digital signature;
generating a watermark pattern based on the certificate;
combining the watermark pattern with the training sample to generate a watermarked training sample;
pairing the watermarked training sample with a watermark classification label; and
providing to the neural network model the paired watermarked training sample and watermark classification label for training.

2. The computer-implemented method of claim 1, further comprising:
generating the watermark pattern based on the digital signature; and
generating the watermark classification label based on the digital signature.

3. The computer-implemented method of claim 1, wherein the digital signature is generated by encrypting the verification data using a private key of an owner of the neural network model, wherein the verification data is a verifier string including ownership information.

4. The computer-implemented method of claim 3, wherein the digital signature is a bit-string used as a seed value for one-way hashing.

5. The computer-implemented method of claim 4, wherein the verifier string further includes a random number.

6. The computer-implemented method of claim 4, wherein generating the watermark classification label and generating the watermark pattern further comprises:
performing a one-way hash operation on the digital signature to generate the seed value;
generating the watermark classification label based on a first one-way hash operation on the seed value; and
generating the watermark pattern based on a second one-way hash operation on the seed value,
wherein the training sample is an image and the step of combining the watermark pattern with the training sample to generate the watermarked training sample further comprises:
performing third and fourth one-way hash operations on the seed value to generate a position of the watermark pattern relative to a height and width of the training sample.

7. The computer-implemented method of claim 1, further comprising:
receiving the watermark classification label; and
generating the watermark pattern based on the watermark classification label.

8. The computer-implemented method of claim 7, wherein the digital signature is generated by encrypting the verification data using a private key of an owner of the neural network model, wherein the verification data is a verifier string including the ownership information and the watermark classification label.

9. The computer-implemented method of claim 7, wherein the watermark pattern is generated based on a one-way hash operation on the watermark classification label and a random number.

10. The computer-implemented method of claim 7, wherein the watermark classification label is predetermined by an owner of the neural network model.

11. The computer-implemented method of claim 1, wherein combining the watermark pattern with the training sample to generate the watermarked training sample further comprises:
transforming the training sample from a first domain to a second domain;
combining the watermark pattern with the training sample in the second domain to generate a watermarked training sample in the second domain; and
inverse transforming the watermarked training sample in the second domain to generate a watermarked training sample in the first domain.

12. The computer-implemented method of any one of claim 1, further comprising:
receiving a classification label for the training sample;
providing the training sample and the classification label as input to train the neural network,
wherein the training sample and the classification label preferably comprise one pair of a plurality of pairs of normal training data provided to the neural network; and
the paired watermarked training sample and the watermarked classification label comprise one pair of a plurality of pairs of watermarked training data provided to the neural network to inject a watermark,
wherein the classification label and the watermark classification label more are different.

13. (canceled)

14. A computer-implemented method of verifying a secured watermark generated or generatable by a a computer-implemented method of providing a secured watermark to a neural network model, by: receiving a training sample for watermarking; receiving verification data about the neural network; generating a digital signature based at least on the verification data; generating a certificate for the neural network model, the certificate including the digital signature and the verification data used in the generation of the digital signature; generating a watermark pattern based on the certificate; combining the watermark pattern with the training sample to generate a watermarked training sample; pairing the watermarked training sample with a watermark classification label; and providing to the neural network model the paired watermarked training sample and watermark classification label for training, the computer-implemented method of verifying the secured watermark comprising:
receiving a neural network model;
receiving a certificate of the neural network model including a verification data and a digital signature of the owner of the neural network;
verifying the certificate of the owner using a public key of the owner;
receiving a paired watermarked training sample and watermark classification label generated based on the verified digital signature or the verification data;
querying the neural network model using the watermarked training sample;
receiving an output classification label based on the query;
comparing the output classification label with the watermark classification label;
determining the neural network model belongs to the owner when the output classification label and the watermark classification label are the same,
receiving a plurality of paired watermarked training samples and watermark classification labels generated based on the verified digital signature or the verification data;
querying the neural network model using the plurality of watermarked training samples;
receiving a plurality of output classification labels based on the queries;
comparing the respective output classification labels and watermark classification labels; and
determining the neural network model belongs to the owner when a percentage of the output classification label and the watermark classification label matching exceeds a predetermined threshold.

15. A computer program product comprising instructions which, when the program is executed by a computer, cause the computer to provide a secured watermark to a neural network model, by performing operations comprising:
receiving a training sample for watermarking;
receiving verification data about the neural network;
generating a digital signature based at least on the verification data;
generating a certificate for the neural network model, the certificate including the digital signature and the verification data used in the generation of the digital signature;
generating a watermark pattern based on the certificate;
combining the watermark pattern with the training sample to generate a watermarked training sample;
pairing the watermarked training sample with a watermark classification label; and
providing to the neural network model the paired watermarked training sample and watermark classification label for training.
